(19) United States
(12) Patent Application Publication
(10) Pub. No.: US 2009/0116348 A1
(43) Pub. Date: May 7, 2009

(54) OFF-TRACK DETECTION CIRCUIT

(76) Inventor: Yasuo Nakata, Osaka (JP)

Correspondence Address: WENDEROTH, LIND & PONACK L.L.P., 1030 15th Street, N.W., Suite 400 East, Washington, DC, 20005-1503, US

(21) Appl. No.: 11/916,390

(22) PCT Filed: May 31, 2006
(86) PCT No.: PCT/JP2006/310865

§ 371 Date: Dec. 3, 2007

(30) Foreign Application Priority Data
Jun. 3, 2005 (JP) 2005-163933

(51) Int. Cl. G11B 7/09; G11B 7/00

(52) U.S. Cl. 369/44.32; 369/53.18; G9B/7; G9B/7.061

(57) ABSTRACT

In a state where vibration is constantly detected, a protection function by a vibration detection circuit loses effectiveness, and thereby there may possibly arise a malfunction of an off-track detection circuit due to a pseudo-generated off-track signal. An off-track detection circuit which is capable of preventing malfunction due to a pseudo-generated off-track signal and of maintaining stable reproduction even when being under vibration, is provided by constructing the circuit not to judge as off-track when a reproduction synchronization signal is detected.

### TECHNICAL FIELD

The present invention relates to an off-track detection circuit, and more particularly to one which effectively detects an off-track and optimizes its operation so that more stable reproduction state can be maintained in a disc system such as an optical disc device.

### BACKGROUND ART

For carrying out a high-quality signal reproduction in disc devices, it is preferable that a laser spot is always maintained in just-focus with respect to the signal recording surface. Similarly, it is also preferred that the laser spot is always maintained in just-on-track with respect to the track on the signal recording surface. However, it cannot be avoided that the laser spot would vibrate in a direction orthogonal to the disc recording surface (hereinafter referred to as a focus direction) as well as in a direction orthogonal to the track advancing direction (hereinafter referred to as a tracking direction) due to the machine accuracy of the disc rotation mechanism, the flat surface precision of the disc itself, or external disturbance.

Therefore, disc devices are provided with a focus actuator for driving an objective lens of a pickup in the focus direction, and a focus servo is taken so that the recording surface of the disc and the laser spot are always in just-focus. Similarly, a tracking servo is also taken in the disc tracking direction so that the laser spot is always in just-on-track.

However, in these kinds of disc devices, it cannot be avoided that they are subjected to vibrations and impacts from outside in such as taking along the same, which results in inhibition of the focus servo or the tracking servo. For this problem, a construction in which vibrations are detected utilizing that the tracking error signals are generated by the vibrations, and the gains of the focus servo and the tracking servo are increased based on the vibration detected results, so as to prevent the run out of the focus servo or the tracking servo, is provided.

However, when strong impacts and the like are applied to the disc device, there may be cases where only an increase in the servo gain cannot correspond to those situations. Since in such cases the focus servo or the tracking servo runs out of the ranges of their servo control, generally the servo control is once turned off, and then the servo control is returned to within the ranges of servo control. Here, as for the tracking servo, it is noted that a function of a tracking off detection circuit, for judging whether the tracking servo control is turned off or not is important, and various systems are considered as disclosed in Patent Document 1.

FIG. 11 is a block diagram illustrating such a kind of conventional off-track detection circuit 110.

In FIG. 11, reference numeral 1 denotes a vibration detection circuit for detecting vibrations from a tracking error signal and the like, reference numeral 2 denotes an off-track detection circuit for detecting an off-track position by using depression and the like of the reproduced signal, reference numeral 3 denotes a first AND circuit for outputting a logical AND of the output of the vibration detection circuit 1 and the output of the off-track detection circuit 2, and reference numeral 4 denotes an off-track detected signal as the output of the first AND circuit 3.

Hereinafter, an operation of the conventional off-track detection circuit 110 constructed as described above will be described.

Conventionally, a protection function (mask function) that considers an off-track signal in a time during when vibrations are not detected (where the servo is stable) as noise on the circuit is incorporated in an off-track detection circuit, thereby preventing the malfunction of the off-track judgment. In the off-track detection circuit 110 shown in FIG. 11, there is provided the first AND circuit 3 to accomplish the protection function consider an off-track signal in a time during when vibrations are not detected as noise on the circuit. That is, it is judged as being in off-track only if there is detected an off-track signal, in a state where vibrations are detected.

In recent years, along with the prevalence of CD-R/RW discs and the increase in the disc distribution amount, there may occur RF signal failures on track caused by pit lacks in the manufacture of a disc, dye failures in CD-R/RW medium, and further, link failures in writing, thereby equivalently arising depressions toward lower side in the RF signals (equivalent to being in an off-track state). For this, even the conventional circuit would not arise a problem because the protection function that considers the off-track signal in a time during when vibrations are not detected as noise on the circuit is operated during the time when vibrations are not detected. In cases where a disc device is used in a portable device or in an in-vehicle device, however, the disc device would be often exposed in vibrating states, thereby always being in vibration detected state.

FIG. 12 is a diagram illustrating an operating condition of the conventional off-track detection circuit 110, and FIG. 12(a) shows a tracking error signal equivalently showing the vibrating state of the disc device, FIG. 12(b) shows the output of the vibration detection circuit 1, FIG. 12(c) shows the output of the off-track detection circuit 2, and FIG. 12(d) shows an off-track detected signal 4.

First, if vibrations are applied to the disc device as shown in FIG. 12(a), the vibrations are detected by the vibration detection circuit 1 as shown in FIG. 12(b). When noises or depressions toward lower side in the RF signal are generated in the off-track detection circuit 2, even when no off-track is actually occurred, an off-track detected signal is outputted through the first AND circuit 3. In other words, in always vibration detecting state, the protection function to consider the off-track signal in the time during when the vibrations are not detected as noises on the circuit would have no effectiveness, and thereby there may possibly arise a malfunction of the off-track detection circuit 110 due to the pseudo-generated off-track signals.

Patent document 1: Japanese published patent application Hei. 8-45128 (FIG. 2)

### Problems to be Solved by the Invention

In this way, the conventional off-track detection circuit 110 would lose the effectiveness of the protection function to consider an off-track signal in a time during when vibrations are not detected as noise on the circuit, when it is in the always vibration detecting state, and thereby there were problems that a malfunction of the off-track detection circuit 110 is generated due to the pseudo-generated off-track signals.

The present invention is made to solving the above-described problems, and has for its object to provide an off-track detection circuit which can prevent occurrence of the malfunction of an off-track detection circuit due to the pseudo-generated off-track signal as well as can keep stable reproduction state even under a vibration detecting state.

### Measures for Solving the Problems

In order to solve the above-described problems, an off-track detection circuit according to claim 1 of the present invention comprises an off-track detection circuit for detecting whether a pickup of a disc device is off the track on a disc, the off-track detection circuit validating an off-track signal when vibrations of the disc device are detected, wherein it is not judged as being off-track during when a reproduction synchronization signal is detected.

An off-track detection circuit according of claim 2 of the present invention is characterized in comprising, in claim 1, that it is not judged as being off-track during when a reproduction synchronization signal is detected, with making the off-track signal being invalid.

An off-track detection circuit according to claim 3 of the present invention is characterized in comprising, in claim 1 or 2, that control by the reproduction synchronization signal is validated during when a tracking loop is closed.

An off-track detection circuit according to claim 4 of the present invention is characterized in comprising, in claim 1 or 2, that control using the reproduction synchronization signal is being invalid from the time when the tracking loop was closed to the time when a tracking lock signal is detected.

An off-track detection circuit according to claim 5 of the present invention is characterized in comprising, in claim 4, that a tracking lock signal is detected when the amplitude of the tracking error signal is smaller than a predetermined value.

An off-track detection circuit according to claim 6 of the present invention is characterized in comprising, in claim 4, the tracking lock signal is detected during when the off-track signal is not detected for a predetermined period of time.

An off-track detection circuit according to claim 7 of the present invention is characterized in comprising, in any of claims 1 to 6, that the off-track detection is being invalid during when a defect signal is detected.

### EFFECTS OF THE INVENTION

According to the off-track detection circuit of claim 1 or 2, since it is not judged as being off-track during when a reproduction synchronization signal is detected, it is possible to prevent false detection of off-track from occurring due to a pseudo-generated off-track signal even when the device is under vibration.

According to the off-track detection circuit of claim 3, since in claim 1 or 2, control by the reproduction synchronization signal is validated during when a tracking loop is closed, a regular off-track detection signal can be obtained without affecting an off-track signal in a time during when the tracking loop is opened.

According to the off-track detection circuit of claim 4, since in claim 1 or 2, control using the reproduction synchronization signal is being invalid during the period from the time when the tracking loop was closed to the time when a tracking lock signal is detected, the control by the reproduction synchronization signal becomes effective for the first time when the tracking servo becomes stable after the tracking loop is closed, and thus there would arise no protection operation to consider the off-track signal at the time when the vibrations are not detected due to the reproduction synchronization signal as noises on the circuit.

According to the off-track detection circuit of claim 5, since in claim 4, a tracking lock signal is detected when the amplitude of a tracking error signal is smaller than a predetermined value, it is possible to judge that the tracking servo has become stable.

According to the off-track detection circuit of claim 6, since in claim 4, a tracking lock signal is detected during when an off-track signal is not detected for a predetermined period of time, it is possible to judge that the tracking servo has become stable.

According to the off-track detection circuit of claim 7, since in any of claims 1 to 6, off-track detection is being invalid during when a defect signal is detected, it is possible to prevent malfunction of the off-track detection circuit due to run out of synchronization which may occur during when it passes through on defects, or a pseudo-generated off-track signal.

### BRIEF DESCRIPTION OF THE DRAWINGS

FIG. 1 is a block diagram illustrating an off-track detection circuit in an optical disc device according to a first embodiment of the present invention.

FIG. 2 is a waveform diagram illustrating an operation of the off-track detection circuit according to the first embodiment.

FIG. 3 is a block diagram illustrating an off-track detection circuit in an optical disc device according to a second embodiment of the present invention.

FIG. 4 is a waveform diagram illustrating an operation of the off-track detection circuit according to the second embodiment.

FIG. 5 is a block diagram illustrating an off-track detection circuit in an optical disc device according to a third embodiment of the present invention.

FIG. 6 is a waveform diagram illustrating an operation of the off-track detection circuit according to the third embodiment.

FIG. 7 is a waveform diagram illustrating an operation of a tracking servo lock signal generation circuit in the third embodiment.

FIG. 8 is a waveform diagram illustrating an operation of the tracking servo lock signal generation circuit in the third embodiment.

FIG. 9 is a block diagram illustrating a construction of an off-track detection circuit according to a fourth embodiment of the present invention.

FIG. 10 is a waveform diagram illustrating an operation of the off-track detection circuit according to the fourth embodiment of the present invention.

FIG. 11 is a block diagram illustrating a construction of an optical disc device as a conventional signal reproduction device.

FIG. 12 is a waveform diagram illustrating an operation of the optical disc device as a conventional signal reproduction device.

### DESCRIPTION OF REFERENCE NUMERALS

1 . . . vibration detection circuit
2 . . . off-track detection circuit
3 . . . first AND circuit
4 . . . off-track detection circuit
5 . . . reproduction synchronization signal generation circuit
6 . . . first inverter
7 . . . tracking servo control signal
8 . . . second AND circuit
9 . . . tracking servo lock signal generation circuit
10 . . . second inverter
11 . . . RS flip-flop
12 . . . defect detection signal generation circuit
13 . . . third inverter
14 . . . third AND circuit

### THE BEST MODE FOR CARRYING OUT THE INVENTION

The present invention provides an off-track detection circuit which can prevent the malfunction of an off-track detection circuit due to a pseudo-generated off-track signal and which can maintain the stable reproduction state even under the detected vibration condition where vibrations are detected.

That is, the off-track detection circuit of the present invention is an off-track detection circuit which is constructed to validate the off-track signal during when a vibration detection signal is detected, which is characterized in that it does not judge as being off-track during when a reproduction synchronization signal is detected. Thereby, even when being under vibrations, it is possible to prevent erroneous detection of off-track due to the pseudo-generated off-track signal.

Further, since the control by the reproduction synchronization signal is validated when the tracking loop is closed, a normal off-track detection signal can be obtained without being influenced by the off-track detection signal that is obtained when the tracking loop is opened.

Further, since the control using a reproduction synchronization signal is being invalid during the period from when the tracking loop is closed to when the tracking rock signal is detected, the protection operation by the reproduction synchronization signal is not generated unnecessarily.

Further, since the tracking lock signal is detected during when the amplitude of the tracking error signal is smaller than a predetermined value, it is possible to judge that the tracking servo has become stable.

Further, since the tracking rock signal is detected during when the off-track signal is not detected for a predetermined period of time, it is possible to judge that the tracking servo has become stable.

Further, since off-track detection is being invalid during when a defect signal is detected, it is possible to prevent the malfunction of the off-track detection circuit due to out of synchronization which may possibly occur when it passes through on defects or a pseudo-generated off-track signal.

### FIRST EMBODIMENT

A disc device according to a first embodiment of the present invention is an off-track detection circuit which validates an off-track signal when a vibration detection signal is detected, and which does not judge as being off-track when a reproduction synchronization signal is detected. Thereby, false detection of the off-track due to a pseudo-generated off-track signal can be prevented even when being under vibrations.

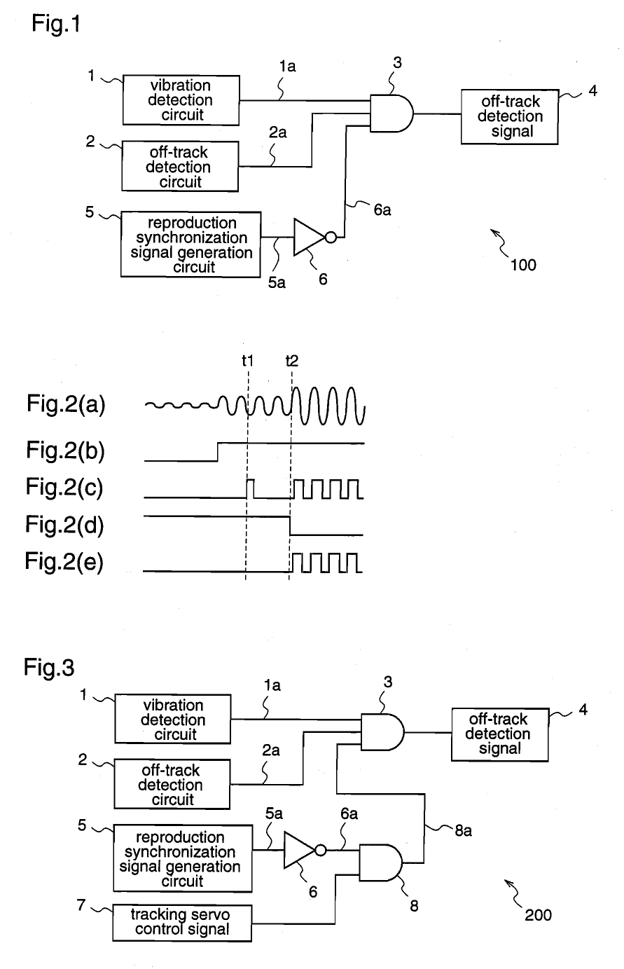

FIG. 1 is a block diagram illustrating an off-track detection circuit 100 according to a first embodiment of the present invention.

In FIG. 1, reference numeral 1 denotes a vibration detection circuit for detecting vibrations from a tracking error signal and the like, reference numeral 2 denotes an off-track detection circuit for detecting an off-track position by using depression and the like of the reproduced signal, reference numeral 3 denotes a first AND circuit for outputting a logical AND of the output 1a of the vibration detection circuit 1, the output 2a of the off-track detection circuit 2, and the output 6a of a first inverter 6. Reference numeral 4 denotes an off-track detection signal as the output of the first AND circuit 3, reference numeral 5 denotes a reproduction synchronization signal generation circuit for generating a reproduction synchronization signal 5a which equivalently represents the quality of the reproduced signal by extracting a reproduction synchronization pattern that is contained in the reproduced signal, and reference numeral 6 denotes a first inverter which receives the output 5a of the reproduction synchronization signal generation circuit 5 and carries out logical inversion of the same.

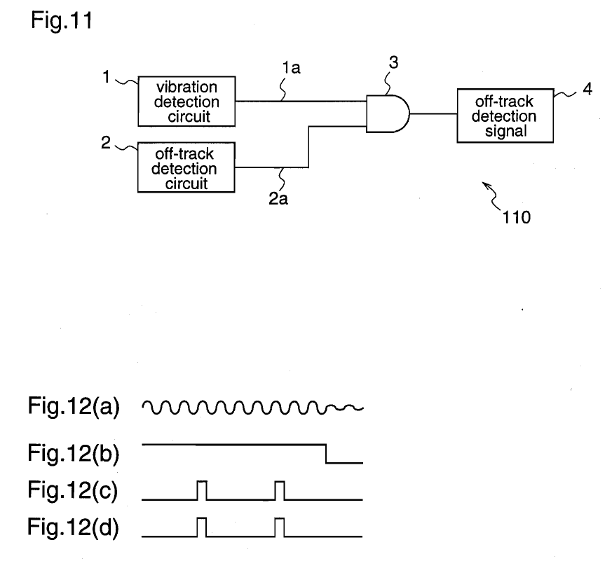

The circuit according to the first embodiment shown in FIG. 1 is constituted by adding, to the conventional construction shown in FIG. 11, the reproduction synchronization circuit 5 and the first inverter 6, and inputting the output 6a of the first inverter 6 to the first AND circuit 3. While in the construction shown in FIG. 1, an inverter and AND circuits are used, other logical circuits may be used in combination if a logically equivalent one is constituted.

While generally a synchronization pattern is embedded in a recording signal in a specified format in the reproduction synchronization signal generation circuit 5, this circuit is operated to extract a synchronization pattern obtained from ate reproduction signal, and generate a synchronization detection signal which serves as an indicia for judging whether the data is correctly read out or not, i.e., a reproduction synchronization signal, by the synchronization establishment, the synchronization protection, and the interpolation processing. In other words, by obtaining the reproduction synchronization signal, it is possible to judge that the tracking servo is normally operated, and the track is normally scanned. Accordingly, by taking that there is a reproduction synchronization signal as a protection condition and incorporating this condition in the off-track detection circuit, it is possible to judge success and failure of the normal scan of the track.

FIG. 2 is a diagram for explaining the operation of the off-track detection circuit 100 according to the first embodiment, i.e., a waveform chart illustrating respective waveforms in the protection operation using the reproduction synchronization signal.

In FIG. 2, the abscissa indicates time and the ordinate indicates voltage.

FIG. 2(a) shows a tracking error signal which equivalently indicates the vibration condition of the disc device, FIG. 2(b) shows the output 1a of the vibration detection circuit 1, FIG. 2(c) shows the output 2a of the off-track detection circuit 2, FIG. 2(d) shows the output 5a of the reproduction synchronization signal generation circuit 5, and FIG. 2(e) shows the off-track detection signal 4.

Next, an operation of the off-track detection circuit 100 in the disc device according to the first embodiment will be described.

First, when vibrations are added to the disc device as shown in FIG. 2(a), the vibrations are detected by the vibration detection circuit 1 as shown in FIG. 2(b). If noises or depression toward lower side are generated in the reproduced signal which is inputted to the off-track detection circuit 2 at time t1, an off-track signal 2a is detected even when off-track is not actually taken place. Here, since the output 5a of the reproduction synchronization signal generation circuit 5 indicates the detected state, the off-track detection signal 4 will not be outputted by passing through the first AND circuit 3. Therefore, it can be seen that influences due to pseudo-generated off-track signals are eliminated in the state where no off-track is taken and a reproduction synchronization signal is detected, i.e., in the state where data can generally be read. Further, in cases where an off-track actually occurred due to factors such as vibrations being added (at time t2), the data naturally cannot be read, and the reproduction synchronization signal would not be detected, and real off-track states would be detected. That is, by judging the track scanning state from the reproduction synchronization signal even when the system is in the vibration detected state, it is possible to prevent the malfunction of the off-track detection circuit due to the pseudo-generated off-track signal.

Meanwhile, though a method using both the vibration detection circuit and the reproduction synchronization signal is shown, simply a vibration detection circuit may be deleted, and only the reproduction synchronization signal generation circuit is employed to perform protection of the off-track detection circuit.

In such off-track detection circuit of the first embodiment, a synchronization pattern that is obtained from the reproduced signal is extracted by the reproduction synchronization signal generation circuit 5, a synchronization detection signal that serves as an indicia for judging whether the data is read out correctly or not is generated by the synchronization establishment, synchronization protection, and interpolation processing, and it is judged as to whether the tracking servo is normally operated and the track is normally scanned. Thus, an off-track detection circuit which can judge whether the normal scan of tracks are carried out or not with taking that the reproduction synchronization signal is present as a protection condition.

### SECOND EMBODIMENT

A second embodiment of the present invention provides one in which in the off-track detection circuit of the first embodiment, control using a reproduction synchronization signal is validated when a tracking loop is closed, thereby a correct off-track detection signal can be obtained without affecting on off-track detection signals during when the tracking loop is opened.

FIG. 3 is a block diagram illustrating an off-track detection circuit 200 according to the second embodiment of the present invention. In FIG. 3, reference numeral 1 denotes a vibration detection circuit for detecting vibrations from tracking error signals or the like, reference numeral 2 denotes an off-track detection circuit for detecting off-track positions by using depression or the like in the reproduced signal, reference numeral 3 denotes a first AND circuit for outputting a logical AND of the output 1a of the vibration detection circuit 1, the output 2a of the off-track detection circuit 2, and the output 8a of a second AND circuit 8 described later, reference numeral 4 denotes an off-track detected signal which is the output of the first AND circuit 3, reference numeral 5 denotes a reproduction synchronization signal generation circuit which extracts a reproduction synchronization pattern that is included in the reproduced signal and produces the reproduction synchronization signal 5a that equivalently indicates the quality of the reproduced signal, reference numeral 6 denotes a first inverter which receives output 5a of the reproduction synchronization signal generation circuit 5 and carries out logical inversion of the same, and reference numeral 7 denotes a tracking servo control signal which indicates the control state of the tracking servo. Here, the tracking servo control signal 7 is a signal which indicates open or close of the tracking loop, and is not a signal which indicates whether or not the tracking servo is stably implemented. Further, reference numeral 8 denotes a second AND circuit which outputs a logical AND of the output 6a of the first inverter 6 and the tracking servo control signal 7.

The off-track detection circuit of the second embodiment shown in FIG. 3 includes, in addition to the construction of the first embodiment shown in FIG. 1, the tracking control signal 7 and the second AND circuit 8, and makes the output 6a of the first inverter 6 inputted to the second AND circuit 8, and further makes the output 8a of the second AND circuit 8 inputted to the first AND circuit 3. Here, though AND circuits and an inverter are used in the construction shown in FIG. 2 other logical circuits may be employed in combination to constitute an equivalent circuit.

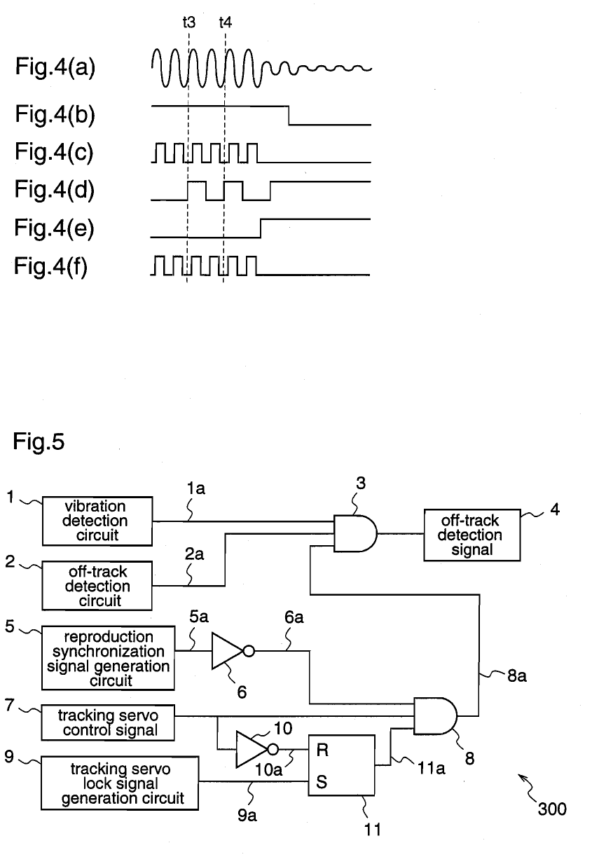

FIG. 4 is a diagram illustrating an operation of the off-track detection circuit 200 according to the second embodiment, and this is a wave form chart illustrating respective waveforms of the protection operation employing the reproduction synchronization signal. In FIG. 4, the abscissa indicates time and the ordinate indicates voltage.

FIG. 4(a) shows a tracking error signal which equivalently indicates the vibration condition of the disc device, FIG. 4(b) shows the output 1a of the vibration detection circuit 1, FIG. 4(c) shows the output 2a of the off-track detection circuit 2, FIG. 4(d) shows the output 5a of the reproduction synchronization signal generation circuit 5, FIG. 4(e) shows the tracking servo control signal 7, and FIG. 4(f) shows the off-track detection signal 4.

Next, an operation of the off-track detection circuit 200 according to the second embodiment will be described.

First of all, when the tracking servo loop transits from its opened state to its closed state as shown in FIG. 4(a), the amplitude of the tracking error signal becomes of a small amplitude and it becomes a state where the servo is taken, i.e., the scanning on tracks is carried out. Similarly, it becomes a state where the vibration detected signal 1a shown in FIG. 4(b) is not detected when the servo is taken and the vibrations are attenuated. Further, it becomes a state where the off-track signal 2a shown in FIG. 4(c) becomes not detected by the servo control on the track. Further, it becomes a state where the tracking servo control signal 7 shown in FIG. 4(e) is detected when the tracking servo loop is detected.

Here, there is a possibility that as the reproduction synchronization signal shown in FIG. 4(d), a particular reproduction pattern is pseudoly read out to enter the detected state even in a state where the tracking loop is not closed, as shown in time t3 and time t4. In the off-track detection circuit 200 of this second embodiment, since the reproduction synchronization signal is masked by the tracking servo control signal 7 at the second AND circuit 8, a correct off-track detected signal is obtained without masking real off-tracks, as shown in FIG. 4(f).

In such off-track detection circuit of the second embodiment, the off-track detection circuit comprises the vibration detection circuit 1, the off-track detection circuit 2, the reproduction synchronization signal generation circuit 5, a circuit for outputting the tracking servo control signal 7, the second AND circuit 8 which takes a logical AND of the inversion signal 6a of the output 5a of the reproduction synchronization signal generation circuit 5 and the tracking servo control signal 7, and the first AND circuit 3 which takes a logical AND of the output 2a of the off-track detection circuit 2 and the output 8a of the second AND circuit 8, wherein the output of the first AND circuit 3 is outputted as the off-track detection circuit 4 to validate control by a reproduction synchronization signal during when the tracking loop is closed. Therefore, a regular off-track detection signal can be obtained without affecting an off-track signal in a time during when the tracking loop is opened.

### THIRD EMBODIMENT

A third embodiment of the present invention provides one in which in the off-track detection circuit of the second embodiment, control using a reproduction synchronization signal is being invalid during the period from the time when a tracking loop was closed to the time when a tracking lock signal is detected, thereby, control by the reproduction synchronization signal is become effective for the first time when the tracking servo becomes stable after the tracking loop is closed, and thus there would arise no protection operation due to a reproduction synchronization signal unnecessarily.

FIG. 5 is a block diagram illustrating an off-track detection circuit 300 according to the third embodiment of the present invention. In FIG. 5, reference numeral 1 denotes a vibration detection circuit for detecting vibration from tracking error signals or the like, reference numeral 2 denotes an off-track detection circuit for detecting off-track positions by using depression or the like in the reproduced signal, reference numeral 3 denotes a first AND circuit for outputting a logical AND of the output 1a of the vibration detection circuit 1, the output 2a of the off-track detection circuit 2, and the output 8a of a second AND circuit 8 described later, reference numeral 4 denotes an off-track detection signal which is the output of the first AND circuit 3, reference numeral 5 denotes a reproduction synchronization signal generation circuit which extracts a reproduction synchronization pattern that is included in the reproduced signal and generates the reproduction synchronization signal 5a that equivalently indicates the quality of the reproduced signal, reference numeral 6 denotes a first inverter which receives output 5a of the reproduction synchronization signal generation circuit 5 and carries out logical inversion of the same, reference numeral 7 denotes a tracking servo control signal which indicates the control state of the tracking servo, reference numeral 8 denotes a second logical AND circuit for outputting a logical AND of the output 6a of the first inverter 6, the tracking servo control signal 7, and the output 11a of an RS flip-flop 11 described later, reference numeral 9 denotes a tracking servo lock signal generation circuit for carrying out lock judgment of the tracking servo, reference numeral 10 denotes a second inverter 2 which receives the tracking servo control signal 7 and carries out logical inversion of the same, reference numeral 11 denotes an RS flip-flop for carrying out a set operation by the output 7a of the second inverter 2 and a reset operation by the output 9a of the tracking servo lock signal generation circuit 9.

The off-track detection circuit of the third embodiment shown in FIG. 5 includes, in addition to the construction of the second embodiment shown in FIG. 3, the tracking servo lock signal generation circuit 9, the second inverter 10, and the RS flip-flop 11, and makes the output 11a of the RS flip-flop 11 inputted to the second AND circuit 8. Though AND circuits, inverters, and an RS flip-flop are used in the construction shown in FIG. 5 other logical circuits may be employed in combination to constitute an equivalent circuit.

The tracking servo lock signal generation circuit 9 is a circuit for judging whether the tracking servo is stably entered in a state of track trace, and it generates a tracking lock signal in FIG. 7(b) when it judges that the amplitude of the tracking signal shown in FIG. 7(a) is within a certain range (power voltage v1-v2 in FIG. 7(a)) for a certain period (time t5-t6), and generates a tracking servo lock signal shown in FIG. 8(b) when it judges that an off-track signal shown in FIG. 8(a) is not detected for a certain period (time t7-t8).

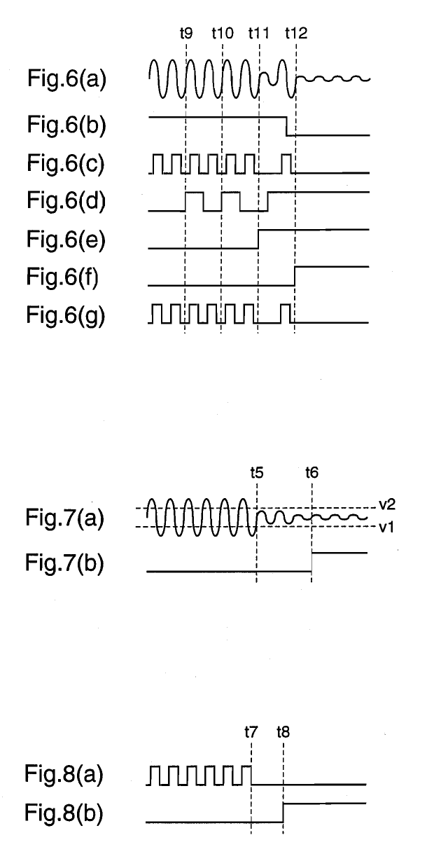

FIG. 6 is a diagram illustrating an operation of the off-track detection circuit 300 according to the third embodiment, and this is a waveform chart illustrating respective waveforms of the protection operation employing the reproduction synchronization signal. In FIG. 6, the abscissa indicates time and the ordinate indicates voltage.

FIG. 6(a) shows a tracking error signal which equivalently indicates the vibration condition of the disc device, FIG. 6(b) shows the output 1a of the vibration detection circuit 1, FIG. 6(c) shows the output 2a of the off-track detection circuit 2, FIG. 6(d) shows the output 5a of the reproduction synchronization signal generation circuit 5, FIG. 6(e) shows the tracking servo control signal 7, FIG. 6(f) shows the tracking servo lock signal 9a which is the output of the tracking servo lock signal generation circuit 9, and FIG. 6(g) shows the off-track detection signal 4.

Next, an operation of the off-track detection circuit 300 according to the third embodiment will be described.

First of all, when the tracking servo loop transits from its opened state to its closed state as shown in FIG. 6(d), the amplitude of the tracking error signal becomes of a small amplitude and it becomes a state where the servo is taken, i.e., the scanning on tracks is carried out. Similarly, it becomes a state where the vibration detected signal 1a shown in FIG. 6(b) is not detected when the servo is taken and the vibrations are attenuated. Further, it becomes a state where the off-track signal 2a shown in FIG. 6(c) becomes not detected by the servo control on the track. Further, it becomes a state where the tracking servo control signal 7 shown in FIG. 6(e) is detected when the tracking servo loop is detected.

Here, there is a possibility that as the reproduction synchronization signal shown in FIG. 6(d), a particular reproduction pattern is pseudoly read out to enter the detected state even in a state where the tracking loop is not closed, as shown in time t9 and time t10. In the track off-track detection circuit 300 of this third embodiment, since the reproduction synchronization signal is masked by the tracking servo control signal 7 at second AND circuit 8, a correct off-track detected signal is obtained without masking real off-tracks, as shown in FIG. 6(g).

Further, when the tracking servo loop is closed at time till, it may fall in an unstable state after a reproduction synchronization signal was detected, as shown at time t12. This may occur during a transitional state up to the servo control enters the stationary state, and the off-track signal generated is likely to indicate a real off-track. In this third embodiment, since control using a reproduction synchronization signal is being invalid until the tracking servo lock signal 9a is detected, no protection operation using the reproduction synchronization signal would be unnecessarily generated.

As described above, the off-track detection circuit according to the third embodiment is provided with the vibration detection circuit 1, the off-track detection circuit 2, the reproduction synchronization signal generation circuit 5, the flip-flop 11 which receives the tracking servo control signal 7 and the output of the tracking servo lock signal generation circuit 9, the second AND circuit which takes a logical AND of the inversion signal of the reproduction synchronization signal by the first inverter 6, the tracking servo control signal 7, and an output of the flip-flop 11, and the first AND circuit 3 which takes a logical AND of the output of the vibration detection circuit 1, the output of the off-track detection circuit 2, and the output of the second AND circuit 8, and the output of the first AND circuit 3 is outputted as the off-track detection signal 4. Generally, there is a possibility that as the reproduction synchronization signal, a particular reproduction pattern is pseudoly read out to enter the detected state even in a state where the tracking loop is not closed. However, in the third embodiment, since the reproduction synchronization signal is masked with the tracking servo control signal at the second AND circuit, a correct off-track detection signal can be obtained, without masking the real off-track.

Further, generally, when the tracking servo loop is closed at time till, it may fall in an unstable state after the reproduction synchronization signal was detected. This may occur during a transitional state up to the servo control enters stationary state, and the off-track signal generated is likely to indicate the real off-track. In this third embodiment, since control by a reproduction synchronization signal is being invalid until the tracking servo lock signal is detected, no protection operation using the reproduction synchronization signal would be unnecessarily generated.

### FOURTH EMBODIMENT

A fourth embodiment of the present invention provides one in which in the off-track detection circuit of the third embodiment, off-track detection is being invalid during when a defect signal is detected, thereby it is possible to prevent malfunction of an off-track detection circuit due to out of synchronization which may possibly occur when it passes through on defects or a pseudo-generated off-track signal.

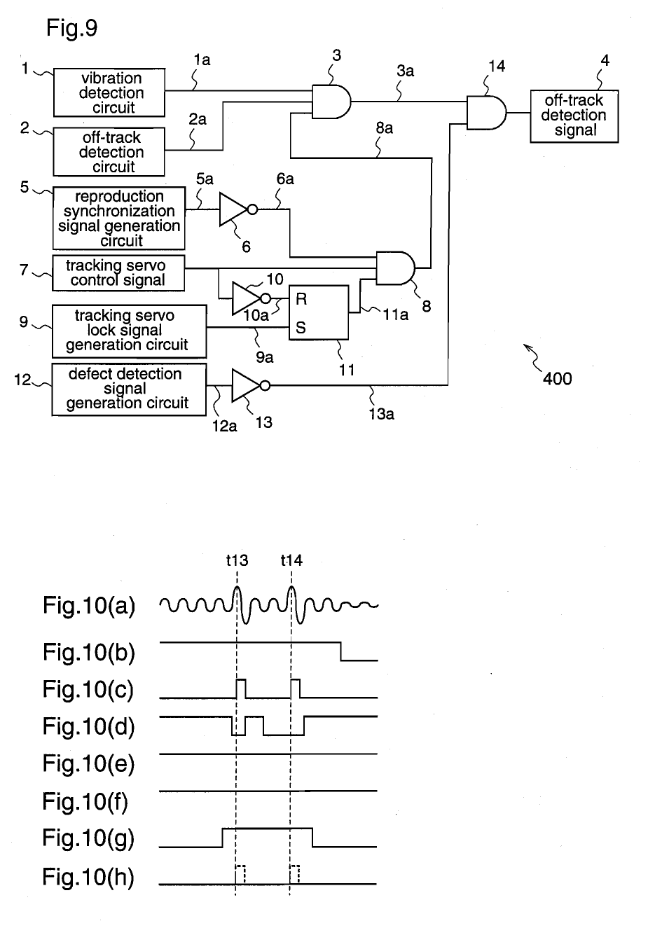

FIG. 9 is a block diagram illustrating an off-track detection circuit 400 according to a fourth embodiment of the present invention. In FIG. 9, reference numeral 1 denotes a vibration detection circuit for detecting vibrations from a tracking error signal and the like, reference numeral 2 denotes an off-track detection circuit for detecting an off-track position by using depression and the like of the reproduced signal, reference numeral 3 denotes a first AND circuit for outputting a logical AND of the output 1a of the vibration detection circuit 1, the output 2a of the off-track detection circuit 2, and the output 8a of a second AND circuit 8 described later, reference numeral 4 denotes an off-track detected signal which is the output of the first AND circuit 3, reference numeral 5 denotes a reproduction synchronization signal generation circuit for generating a reproduction synchronization signal 5a which extracts a reproduction synchronization signal that is included in the reproduced signal and produces the reproduction synchronization signal 5a that equivalently indicates the quality of the reproduced signal, reference numeral 6 denotes a first inverter which receives output 5a of the reproduction synchronization signal generation circuit 5 and carries out logical inversion of the same, reference numeral 7 denotes a tracking servo control signal which indicates the control state of the tracking servo, reference numeral 8 denotes a second AND circuit for outputting a logical AND of the output 6a of the first inverter 6, the tracking servo control signal 7, and the output 11a of an RS flip-flop 11 described later, reference numeral 9 denotes a tracking servo lock signal generation circuit for carrying out lock judgment of the tracking servo, reference numeral 10 denotes a second inverter which receives the tracking servo control signal 7 and carries out logical inversion of the same, reference numeral 11 denotes an RS flip-flop for carrying out a set operation by an output 10a of the second inverter 10 and a reset operation by an output 9a of the tracking servo lock signal generation circuit 9, reference numeral 12 denotes a defect detection signal generation circuit for detecting defects of the reproduced signal, reference numeral 13 denotes a third inverter for carrying out logical inversion of the output 12a of the defect detection signal generation circuit 12, and reference numeral 14 denotes an AND circuit for outputting logical AND of the output 3a of the first AND circuit 3 and an output 13a of the third inverter 13.

Here, the defect detection signal generation circuit 12 is a circuit which perceives defected condition of a reproduction signal to generate a defect detection signal 12a.

The off-track detection circuit according to the fourth embodiment shown in FIG. 9 includes, in addition to the construction of the third embodiment shown in FIG. 5, the defect detection signal generation circuit 12, the third inverter 13, and the third AND circuit 14, wherein a logical AND of the output 3a of the first AND circuit 3 and the output 13a of the third inverter 13 outputted by the third AND circuit 14 is used as the off-track detection signal 4. Though AND circuits, inverters, and an RS flip-flop are used in this construction, other logical circuits may be employed in combination to constitute an equivalent circuit.

FIG. 10 is a diagram illustrating an operation of the off-track detection circuit 400 according to the fourth embodiment, and this is a waveform chart illustrating respective waveforms when defect detection of the reproduction signal is carried out in performing a track tracing. In FIG. 10, the abscissa indicates time and the ordinate indicates voltage.

FIG. 10(a) shows a tracking error signal which equivalently indicates the vibration condition of the disc device, FIG. 10(b) shows the output 1a of the vibration detection circuit 1, FIG. 10(c) shows the output 2a of the off-track detection circuit 2, FIG. 10(d) shows the output 5a of the reproduction synchronization signal generation circuit 5, FIG. 10(e) shows the tracking servo control signal 7, FIG. 10(f) shows the tracking servo lock signal 9a which is the output of the tracking servo lock signal generation circuit 9, FIG. 10(g) shows the defect detection signal 12a generated by the defect detection signal generation circuit 12, and FIG. 10(h) shows the off-track detection signal 4.

Next, an operation of the off-track detection circuit 400 according to the fourth embodiment will be described.

First, when it passes through on defects in a state where the tracking servo is closed, the defect signal 12a is generated by the defect detection signal generation circuit 12, as shown in FIG. 10(g). Since a period during when the defect signal 12a is detected is apart of which reproduction data is defected, the tracking error signal, the off-track signal 2a, and the reproduction synchronization signal 5a are less reliable. That is, it is possible to think that the off-track signal 2a generated at time t13 or t14 is pseudoly generated due to the signal defects rather than to judge that off-track is taken place, and it is possible to think similarly as for the tracking error signal and the reproduction synchronization signal 5a. Accordingly, the off-track detection signal 4 indicated by a dotted line in FIG. 10(h) would be a less reliable signal with respect to off-track detection during when the defect detection signal 12a is generated. Thus, by making off-track detection being invalid with the defect detection signal 12a, it is possible to prevent malfunction of the off-track detection circuit due to out of synchronization which may possibly occur when it passes through on defects or a pseudo-generated off-track signal.

Since the off-track detection circuit according to the fourth embodiment, is provided with the vibration detection circuit 1, the off-track detection circuit 2, the AND circuit 3 for outputting a logical AND of the output of the vibration detection circuit 1, the output of the off-track detection circuit 2, and the output of the second AND circuit 8, the reproduction synchronization signal generation circuit 5, the inverter 6 for carrying out logical inversion of the output of the reproduction synchronization signal generation circuit 5, the second AND circuit for outputting logical AND of the tracking servo control signal 7 and the output of the RS flip-flop 11, the tracking lock signal generation circuit for carrying out lock judgment on the tracking servo, the second inverter 10 for carrying out logical inversion of the tracking servo control signal 7, the RS flip-flop 11 which carries out a set operation by the output of the second inverter and a reset operation by the output 9a of the tracking servo lock signal generation circuit 9, the defect detection signal generation circuit 12 for detecting defects of a reproduction signal, the third inverter 13 for carrying out logical inversion of the output of the defect detection signal generation circuit 12, and the AND circuit 14 for outputting a logical AND of the output of the first AND circuit 3 and the output of the third inverter 13, and makes off-track detection being invalid during when the defect signal is detected, it is possible to prevent malfunction of the off-track detection circuit due to a run out of synchronization or a pseudo-generated off-track signal which may occur during when it passes through on defects.

### INDUSTRIAL APPLICABILITY

Since the off-track detection circuit of the present invention is made not to judge as off-track when a reproduction synchronization signal is detected, erroneous detection of off-track due to the pseudo-generated off-track signal can be prevented even when being under vibration and it is useful as a circuit to be incorporated in an optical disc device or the like. Further it is applicable in the use of not only optical disc but also optical magnetic disc, magnetic disc, or the like.

1. An off-track detection circuit for detecting whether a pickup of a disc device is off the track on a disc, said off-track detection circuit validating an off-track signal when vibrations of the disc device are detected, wherein
it is not judged as being off-track during when a reproduction synchronization signal is detected.

2. (canceled)

3. The off-track detection circuit as defined in claim 1, wherein
control by the reproduction synchronization signal is validated during when a tracking loop is closed.

4. The off-track detection circuit as defined in claim 3, wherein
control by the reproduction synchronization signal is being invalid during the period from the time when the tracking loop was closed to the time when a tracking lock signal is detected.

5. The off-track detection circuit as defined in claim 4, wherein
a tracking lock signal is detected during when the amplitude of the tracking error signal is smaller than a predetermined value.

6. The off-track detection circuit as defined in claim 4, wherein
the tracking lock signal is detected during when the off-track signal is not detected for a predetermined period of time.

7. The off-track detection circuit as defined claim 1, wherein
the off-track detection is being invalid during when a defect signal is detected.

8. The off-track detection circuit as defined in claim 3, wherein
the off-track detection is being invalid during when a defect signal is detected.

9. The off-track detection circuit as defined in claim 4, wherein
the off-track detection is being invalid during when a defect signal is detected.

10. The off-track detection circuit as defined in claim 5, wherein
the off-track detection is being invalid during when a defect signal is detected.

11. The off-track detection circuit as defined in claim 6, wherein
the off-track detection is being invalid during when a defect signal is detected.
